(19) United States
(12) Patent Application Publication
(10) Pub. No.: US 2012/0017930 A1
(43) Pub. Date: Jan. 26, 2012

(54) HAIR COLOR APPLICATOR AND RELATED METHODS

(76) Inventor: Tawny Lee Nance, Wausau, WI (US)

(21) Appl. No.: 12/839,718

(22) Filed: Jul. 20, 2010

(51) Int. Cl. A61Q 5/10; A45D 24/16

(52) U.S. Cl. 132/208; 132/120

(57) ABSTRACT

An applicator for the application of a coloring agent to hair is disclosed herein. In various aspects, the applicator includes a handle secured to the handle generally proximate a handle end. A brush and a companion brush are secured to the axle and are rotationally positionable about the axle. The applicator may be used to apply a coloring agent in coordinated patterns to the hair.

### BACKGROUND OF THE INVENTION

1. Field of the Invention

The apparatus and related methods disclosed herein relate to the coloring of hair and, in particular, to tools for the application of a coloring agent to hair.

2. Background

Various applicators including brushes and blades have been devised for the application of a coloring agent, including various dyes, bleaches, paints, and so forth, to hair. In addition, assorted methods for selectively coloring hair have been developed. For example, foils, which are thin sheets of metal or plastic foil, may be inserted into the hair with portions of the hair to be colored arrayed upon a foil surface of the foil. The hair arrayed upon the foil surface may then be selectively colored by the selective application of the coloring agent thereto in order to achieve various aesthetic effects. The coloring agent may be applied to the hair arrayed upon the foil surface of the foil to form various sections of color including streaks, swirls, dabs, and so forth, and it may be desirable to coordinate the placement of the sections of color in various ways. For example, it may be desirable to place sections of coloring agent in generally parallel sections including other coordinated patterns, and it may be desirable to interpose other sections of coloring agent between these parallel sections. In addition, it may be desirable to apply coordinated swirls of coloring agent to hair apart from the foil. Furthermore, skilled artisans may develop other techniques for the application of the coloring agent. Currently available applicators may have various shortcomings when used in conjunctions with these techniques of applying coloring agent to hair. Accordingly, there is a need for apparatus as well as related methods the may facilitate various techniques for the application of coloring agents to hair.

### BRIEF SUMMARY OF THE INVENTION

These and other needs and disadvantages are overcome by the apparatus and methods disclosed herein. Additional improvements and advantages may be recognized by those of ordinary skill in the art upon study of the present disclosure.

An applicator for the application of a coloring agent to hair is disclosed herein. In various aspects, the applicator includes a handle. An axle with an axis may be secured to the handle generally proximate a handle end. The applicator, in various aspects, includes a brush rotationally positionable about the axle, and a companion brush rotationally positionable about the axle independent of the brush and set apart from the brush in fixed relationship along the axis.

This summary is presented to provide a basic understanding of some aspects of the apparatus and methods disclosed herein as a prelude to the detailed description that follows below. Accordingly, this summary is not intended to identify key elements of the apparatus and methods disclosed herein or to delineate the scope thereof.

### BRIEF DESCRIPTION OF THE DRAWINGS

FIG. 1 illustrates by perspective view an exemplary implementation of an applicator;

FIG. 2 illustrates by side view the exemplary implementation of the exemplary applicator of FIG. 1 in an exemplary deployment;

FIG. 3A illustrates by side view a detail of portions of the exemplary applicator of FIG. 1;

FIG. 3B illustrates by frontal view a detail of portions of the exemplary applicator of FIG. 1;

FIG. 4A illustrates by frontal view an exemplary concave brush;

FIG. 4B illustrates by bottom view the exemplary concave brush of FIG. 4A;

FIG. 4B illustrates by bottom view the exemplary concave brush of FIG. 4A;

FIG. 4C illustrates by perspective view an exemplary usage of the exemplary concave brush of FIG. 4A;

FIG. 5 illustrates by perspective view an exemplary usage of the exemplary applicator of FIG. 1;

FIG. 6 illustrates by side view an example of the use of the exemplary applicator of FIG. 1;

FIG. 7 illustrates by frontal view exemplary sections of coloring agent as formed by the exemplary applicator of FIG. 1;

FIG. 8 illustrates by frontal view exemplary sections of coloring agent as formed by a plurality of exemplary applicators of the type generally illustrated in FIG. 1; and,

FIG. 9 illustrates by perspective view another exemplary implementation of an applicator.

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof.

### DETAILED DESCRIPTION OF THE INVENTION

An applicator for the application of a coloring agent to hair and related methods of using the applicator are disclosed herein. In various aspects, the applicator may include a handle with an axle secured generally proximate a handle end of the handle. A brush and a companion brush are secured to the axle such that the brush and the companion brush are set apart from one another in fixed relationship to, inter alia, apply coloring agent to form adjacent strips in the hair. The brush and the companion brush are rotatably positionable about the axle. Accordingly, the user may manipulate the rotational position of the brush with respect to the companion brush, and may do so while applying a coloring agent to hair. The brush and or the companion brush may change rotational position during the application of the coloring agent. This may facilitate the application of coloring agent to form adjacent sections of coloring agent in the hair as well as the application of the coloring agent to the hair to render various other artistic effects. In various aspects, the applicator may be employed in conjunction with a foil to apply the coloring agent to hair arrayed upon a foil surface of the foil.

The applicator may be made of various natural or synthetic materials or combinations thereof. For example, the handle of the applicator may be made of wood or plastic, and portions of the brush and the companion brush such as the handles thereof may also be made of wood or plastic. The axle may be made of metal, plastic, or wood, in various aspects. The bristles of the brush, the companion brush, and other brushes disclosed herein may be made of natural materials such as, for example, hog bristle or sable. The bristles of the brush, the companion brush, and other brushes disclosed herein may be made of various synthetic materials such as, for example, nylon or polyester, or combinations of natural and/or synthetic material(s). The bristle set of the brush and the companion brush may have various shapes such as, for example, round, flat, angled, fan shaped, and so forth. The brush and the companion brush may be either substantially the same or may be dissimilar, in various aspects.

A kit is disclosed herein. In various aspects, the kit may include the applicator, a concave brush having a concave bristle set that may be in general conformance to the curvature of a human hairline, and a foil sheet.

Methods of applying the coloring agent to hair are disclosed herein. In various aspects, the methods include the steps of positioning a foil sheet underneath strands of hair with the strands of hair generally organized upon a foil surface of the foil sheet, and applying a coloring agent to portions of the strands of hair using the applicator.

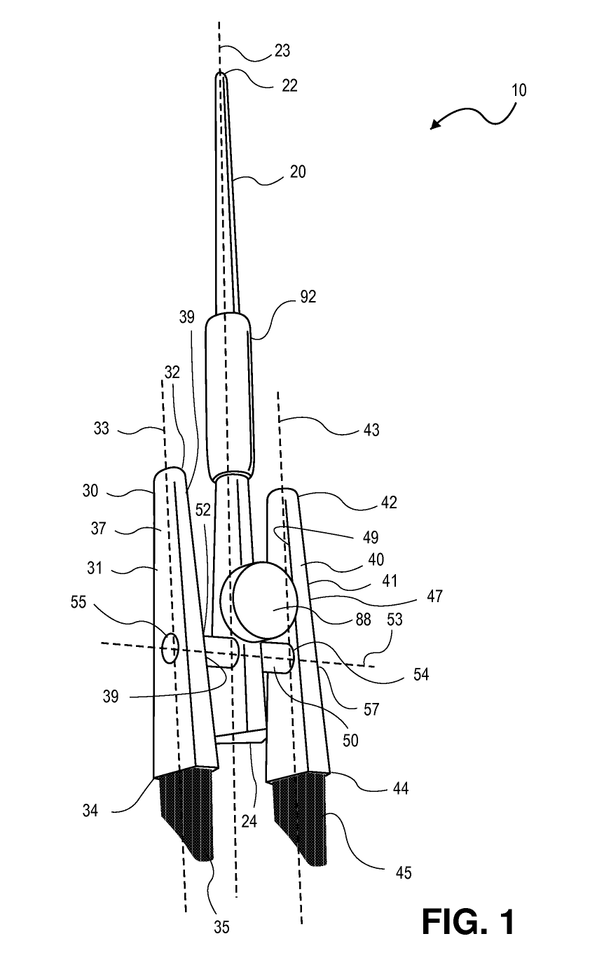

FIG. 1 illustrates an implementation of applicator 10. As illustrated in FIG. 1, applicator 10 includes handle 20 with handle end 22 and handle end 24. Axle 50, which is generally cylindrical in shape in this implementation, is secured to handle 20 generally proximate handle end 24. Brush 30 and brush 40 are rotationally engaged with axle 50 at ends 52, 54, respectively, in this implementation.

As illustrated in FIG. 1, handle 31 of brush 30 is rotatably received upon end 52 of axle 50 to rotate thereabout, so that brush 30 may be rotated into various positions about axle 50. Handle 31 of brush 30 is secured to axle 50 at end 52 by fastener 55, which may be a screw, bolt, rivet and so forth in various implementations, so that brush 31 may rotate about fastener 55. In other implementations (not shown) handle 31 may be rotatably received on the surface of axle 50 to rotate around axle 50 or may be otherwise rotatably received on axle 50. Depending upon the manner in which handle 31 of brush 30 is rotatably received upon axle 50, axle 50 may have various shapes other than the cylindrical shape illustrated in FIG. 1. Brush 30 may be rotationally received upon axle 50 to rotate thereabout in other ways in other implementations.

Handle 41 is rotatably received upon end 54 of axle 50 to rotate thereabout so that brush 40 may be rotated into various positions about axle 50. Handle 41 of brush 40 is rotatably received on axle 50 at end 54 by fastener 57, which, like fastener 55, may be a screw, bolt, rivet and so forth, in various implementations. In other implementations (not shown) handle 41 may be rotatably received on the surface of axle 50 to rotate around axle 50, or may be otherwise rotatably received on axle 50 in various other implementations. Brush 40 may be rotationally received upon axle 50 to rotate thereabout in other ways in other implementations. Thus, as illustrated, brush 40 including bristle set 45 is set apart from the brush 30 including bristle set 35 in fixed relationship along the axis 53—i.e. brush 40 is set at a generally fixed distance apart from brush 30 as measured along axis 53 of axle 50. In this implementation, handles 31, 41 are received upon axle 50 such that handles 31, 41, and, thus, brushes 30, 40 may be rotationally positioned about axle 50 independently of one another. In other implementations (not shown), brushes 30, 40 may be received upon axle 50 such that brushes 30, 40 communicate mechanically with one another, so that brushes 30, 40 are rotationally positionable in tandem.

A user may grasp the applicator 10 by, for example, any or all of handle 20, handle 31, and/or handle 41. The user may manipulate brush 30 by handle 31 to alter the rotational position of brush 30 by rotating brush 30 about axle 50. The user may manipulate brush 40 by handle 41 to alter the rotational position of brush 40 by rotating brush 40 about axle 50. The user may manipulate the rotational position of brushes 30, 40 by pushing upon handles 31, 41 generally proximate handle ends 32, 42, respectively.

Bristle set 35 is located at handle end 34 of handle 31 and may be secured thereto in various ways, as would be readily recognized by those of ordinary skill in the art upon study of this disclosure. As illustrated in FIG. 1, bristle set 35 is angled and is oriented with the elongated dimension of bristle set 35 aligned generally perpendicular to axis 53 of axle 50. Bristle set 45 is located at handle end 44 of handle 41 and is oriented with the elongated dimension of bristle set 45 generally perpendicular to axis 53 of axis 50, as illustrated in FIG. 1. Thus, as illustrated, bristle set 35 and bristle set 45 are generally similar to one another and bristle set 35 and bristle set 45 are generally similarly aligned. In other implementations, the elongated dimension of bristle set 35 and/or bristle set 45 may be aligned generally parallel to axis 53 of axle 50. In various implementations, bristle set 35 may be of generally the same size, shape, orientation, and material as bristle set 45 or bristle set 35 and bristle set 45 may differ from one another in, for example, size, shape, orientation, and/or material.

As illustrated in FIG. 1, applicator 10 includes indicator 92 to indicate the base of the coloring agent with which applicator 10 is being used. Various coloring agents may have various base colors such as red, yellow, blue, violet, and so forth. In applying coloring agents to the hair, it may be important not to confuse the bases of the various coloring agents. Accordingly, indicator 92 displays the color of a base color of a particular coloring agent to allow the user to spot the desired coloring agent having the desired base color and avoid confusing coloring agents having differing base colors. This may be useful when using multiple applicators 10 with multiple coloring agents having assorted base colors. For example, indicator 92 may be colored blue to indicate a coloring agent having a blue base, or indicator 92 may be colored red to indicate a coloring agent having a red base. Applicator 10 with an indicator 92 colored blue or red would then be used with the coloring agent having a blue base color or red base color, respectively. Indicator 92 may be formed of a compliant material and otherwise configured to provide comfort to the user as the user grips handle 20 about indicator 92 in various implementations.

Applicator 10 includes magnet 88, which is shown affixed to handle 20 in FIG. 1. Applicator 10 may be removably secured to any fixture formed of a magnetic material with magnet 88. For example, applicator 10 may be secured to a fixture such as a steel sink where the applicator may drain and/or dry.

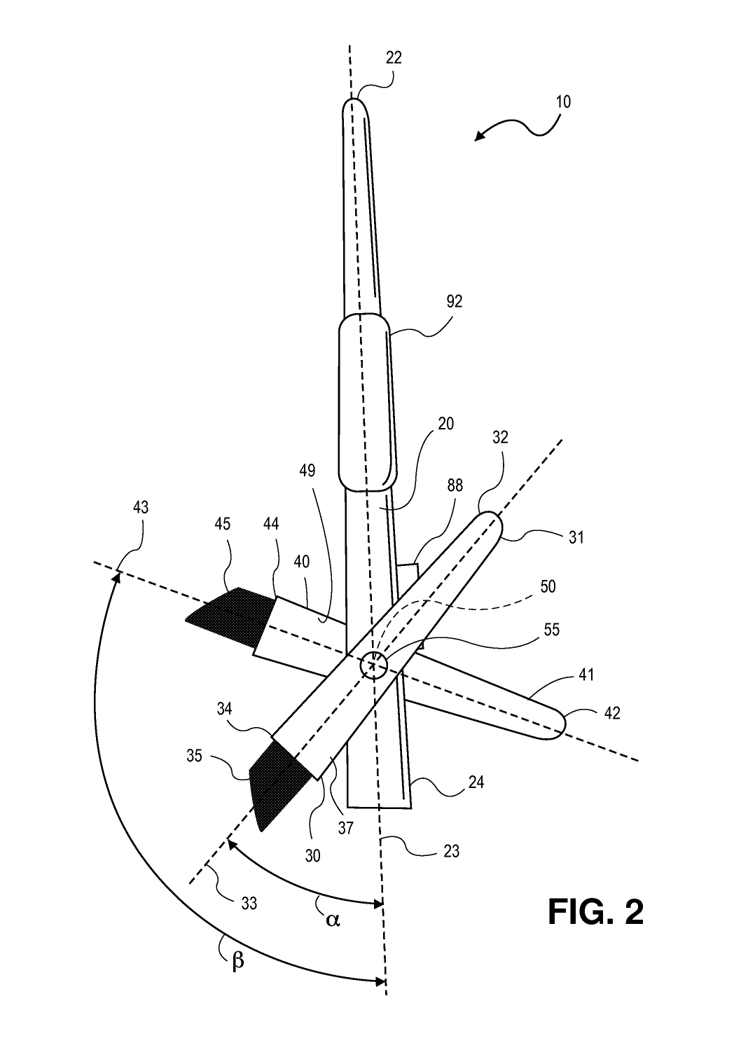

As illustrated in FIG. 2, brush 30 and brush 40 are rotationally positionable about axle 50. Brush 30, as illustrated in FIG. 2, is positioned at angle α defined between axis 23 of handle 20 and axis 33 of handle 31. Brush 40, as illustrated in FIG. 2, is positioned at angle β defined between axis 23 of handle 20 and axis 43 of handle 41. The rotational position of brush 30 and the rotational position of brush 40 may range between 0≦α≦2π and 0≦β≦2π measured clockwise as shown in FIG. 2 from axis 22, respectively.

Brush 30 and brush 40 may be positioned such that angle α is substantially equal to angle β, so that brush 30 is generally rotationally placed in alignment with brush 40 about axle 50. Angle α may differ from angle β, so that brush 30 and brush 40 are in staggered rotational placement about axle 50, which is the placement illustrated in FIG. 2. Brush 30 and brush 40 may be in staggered rotational placement with brush 30 positioned in a half-plane defined by axis 22 (e.g. 0≦α≦π) and brush 40 positioned in the opposing half-plane defined by axis 22 (e.g. β≦β≦2π).

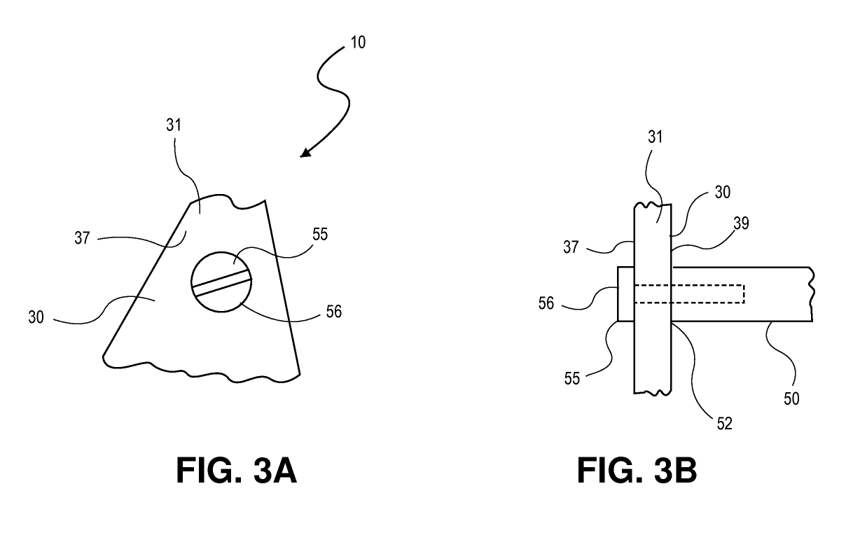

FIGS. 3A and 3B illustrate the manner in which brush 30 is rotationally received upon end 52 of axle 50 in exemplary applicator 10. As illustrated in FIGS. 3A and 3B, handle 31 of brush 30 is secured to axle 50 at end 52 by fastener 55, which is a screw threadedly engaged with axle 50 in this implementation. Brush 30 may rotate about fastener 55 at end 52 of axle 50. Portions of fastener head 56 of fastener 55 are biased against surface 37 of handle 31 to frictionally engage surface 37 as well as secure handle 31 to axle 50, and end 52 of axle 50 is generally biased against surface 39 of handle 31 to frictionally engage surface 39, as illustrated. By adjustment of the engagement of fastener 55 with axle 50 (e.g. tightening or loosening of the fastener 55), the frictional engagement of fastener head 56 with surface 37 and the frictional engagement of end 52 of axle 50 with surface 39 may be altered between minimal frictional engagement, such that handle 31 and hence brush 30 may essentially freely rotate about axle 50, and a maximal frictional engagement, such that handle 31, and, hence, brush 30 are essentially in fixed rotational position with respect to axle 50. At intermediate levels of adjustment of fastener 55, the handle 31 may rotate, for example, as force is applied generally at handle end 32 by the user as the user desires to alter the rotational position of brush 30, or as force is applied generally at the bristle set 35 by brushing bristle set 35 about an object. The user may adjust the frictional engagement between fastener 55, end 52 and surfaces 37, 39, respectively, to adjust the ease of rotation of brush 30 about axle 50, in various implementations. In various implementations, fastener 55 may be configured to be grasped by hand by the user so that the user may adjust fastener 55. For example, fastener 55 may include wings (e.g. a wing nut) or may be in the form of a knurled knob, or similarly configured to be grasped and turned to adjust the frictional engagement of brush 30 with fastener 55 and axle 50 in order to set the force required to rotate brush 30 at a desired level. In other implementations, a tool(s) may be required to adjust fastener 55.

In the implementation of applicator 10, handle 41 of brush 40 is secured to axle 50 at end 54 by fastener 57 (see FIG. 1), and brush 40 may rotate about fastener 57 at end 55 of axle 50. Portions of fastener 57 may bias against surface 47 of handle 41 to frictionally engage surface 47 as well as secure handle 41 to axle 50, and end 54 of axle 50 may generally bias against surface 49 of handle 41 to frictionally engage surface 49. Although the engagement of brush 40 with axle 50 is not specifically illustrated in detail, the remarks with respect to FIGS. 3A, 3B including the adjustment of the frictional engagement between fastener 55, end 52 and surfaces 37, 39, respectively, to adjust the ease of rotation of brush 30 about axle 50, are repeated with respect to brush 40 and the engagement of brush 40 with axle 50.

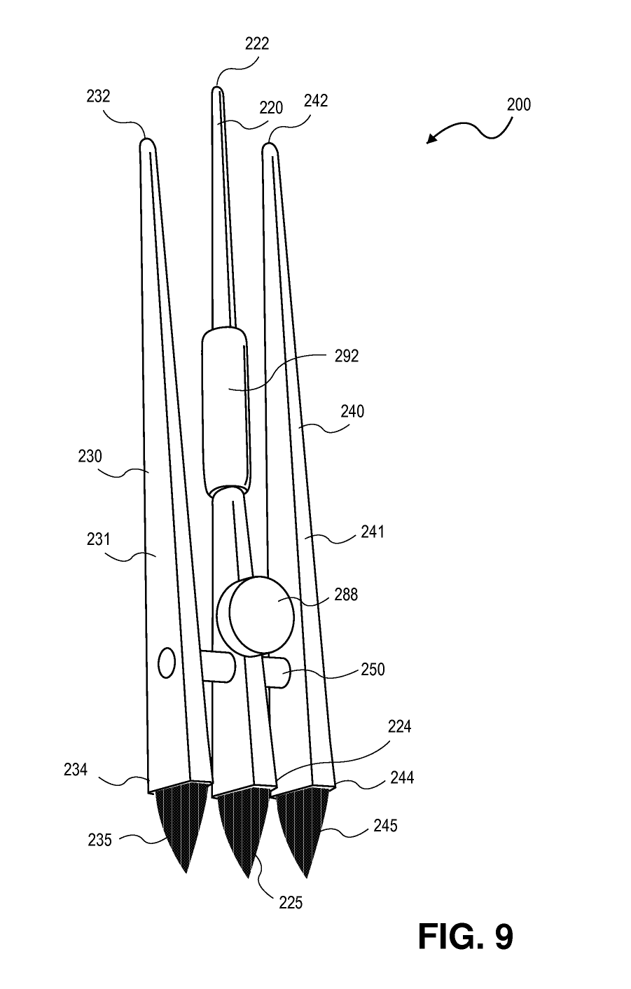

FIG. 9 illustrates another implementation of applicator 200. As illustrated in FIG. 9, applicator 200 includes handle 220 with handle end 222 and handle end 224. Axle 250, which is generally cylindrical in shape in this implementation, is secured to handle 220 generally proximate handle end 224 in this implementation. Brush 230 and brush 240 are rotationally engaged with axle 50 at ends 52, 54, respectively, in this implementation. Applicator 200 includes bristle set 225 located at handle end 224 of handle 220.

As illustrated in FIG. 9, handle 231 of brush 230 is rotatably received upon axle 250 to rotate thereabout, so that brush 230 may be rotated into various positions about axle 250. Handle 241 is rotatably received upon axle 250 to rotate thereabout so that brush 240 may be rotated into various positions about axle 250. Brushes 230, 240 may be rotationally positioned about axle 250 independently of one another in this implementation.

As illustrated in FIG. 9, bristle set 235 is located at handle end 234 of handle 231, bristle set 245 is located at handle end 244 of handle 241, and bristle set 225 is located at handle end 224 of handle 220. Bristle sets 225, 235, 245 are configured similar to large mascara wands in this implementation, but could have various shapes, sizes, and orientations in other implementations. Applicator 200 may be used to color very thin hair, and may color hair without depositing coloring agent upon the scalp. Bristle sets 225, 235, 245 may be either generally similar to one another or may be dissimilar in various implementations.

A user may grasp the applicator 200 by any or all of handle 220, handle 231, and/or handle 241. The user may manipulate brush 230 by handle 231 to alter the rotational position of brush 230 by rotating brush 230 about axle 250. The user may manipulate brush 240 by handle 241 to alter the rotational position of brush 240 by rotating brush 240 about axle 520. The user may manipulate the rotational position of brushes 230, 240 by pushing on handle ends 232, 242 of handles 231, 241 to rotate brushes 230, 240 about axis 250. In this implementation, handle ends 222, 232, 242 are generally coextensive with one another, which may facilitate manipulation of the rotational position of brushes 230, 240 by handles 231, 241, respectively.

As illustrated in FIG. 9, applicator 200 includes indicator 292 to indicate the base of the coloring agent with which application 200 is being used. Applicator 200 includes magnet 288, which is shown affixed to handle 220 in FIG. 9, to allow applicator 200 to be removably secured to a fixture formed of a magnetic material.

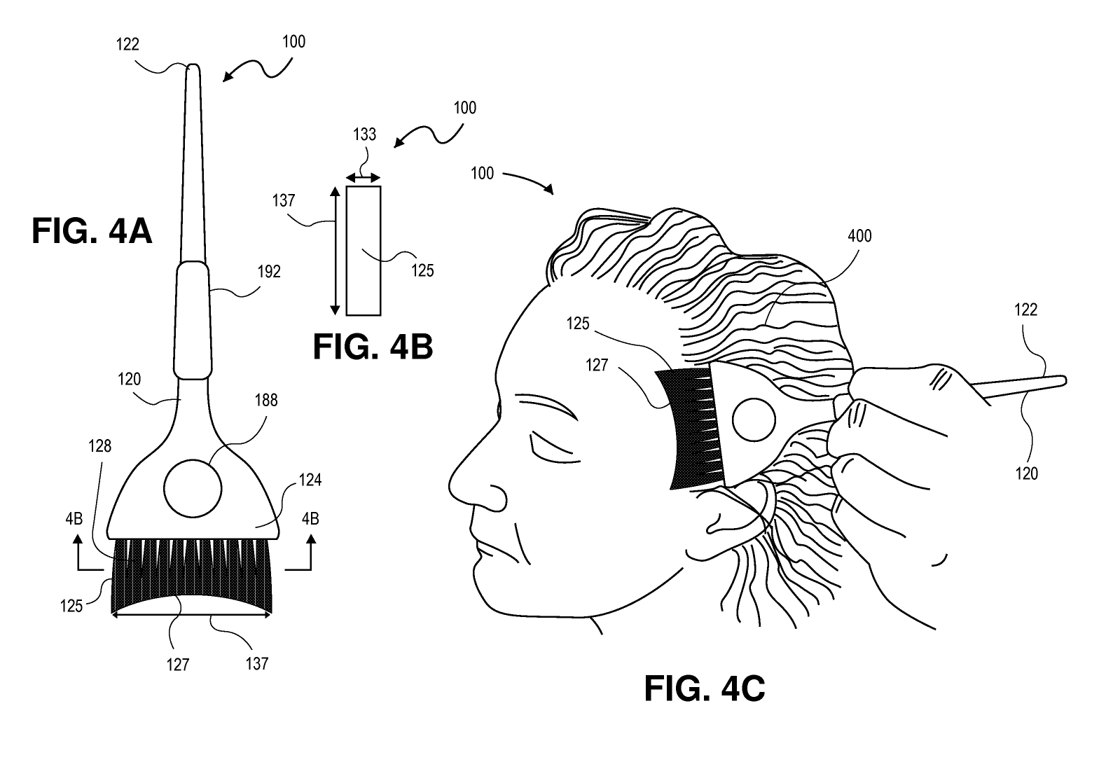

FIG. 4A illustrates a concave brush 100 having a concave bristle set 125 with a concave shaped curvature 127 in general conformance to the convex curvature of a human hairline 400 (FIG. 4C). In various implementations, concave brush 100 may be made of various natural or synthetic materials or combinations thereof. Bristles 128 of bristle set 125 may be made of various synthetic materials such as, for example, nylon or polyester, or combinations thereof. Handle 120 of concave brush 100 has opposing handle ends 122, 124, as illustrated, and bristle set 125 is affixed to handle end 125. Bristle set 125 may be affixed to handle end 124 of handle 120 in various ways, as would be recognized by those of ordinary skill in the art upon study of this disclosure.

As illustrated in FIG. 4B, bristle set 125 may have a generally rectangular cross-sectional shape with a longitudinal dimension 137 and transverse dimension 133 configured such that the longitudinal dimension 137 is greater than the transverse dimension 133, as illustrated. In this implementation, the curvature 127 of bristle set 125 is oriented along the longitudinal dimension 137. Bristle set 125 may be generally the same length or may be curved, tapered, and so forth in the transverse dimension 133.

As illustrated in FIG. 4A, concave brush 100 includes indicator 192 to indicate the base of the coloring agent with which concave brush 100 is being used. Concave brush 100, as illustrated, includes magnet 188, which is illustrated as affixed to handle 120. Concave brush 100 may be removably secured to a fixture such as a sink with magnet 188.

In use, the user may grasp the concave brush 100 and apply a coloring agent to hair generally proximate the hairline, to which the curvature 127 of bristle set 125 generally conforms, as illustrated in FIG. 4C. The curvature 127 may facilitate the application of the coloring agent to hair generally proximate the hairline while avoiding placement of the coloring agent upon the skin and the resultant discoloration of the skin. In various implementations, concave brush 100 maybe included in a kit with an applicator, such as applicator 10, and may be used generally in conjunction with the applicator to apply coloring agent to hair.

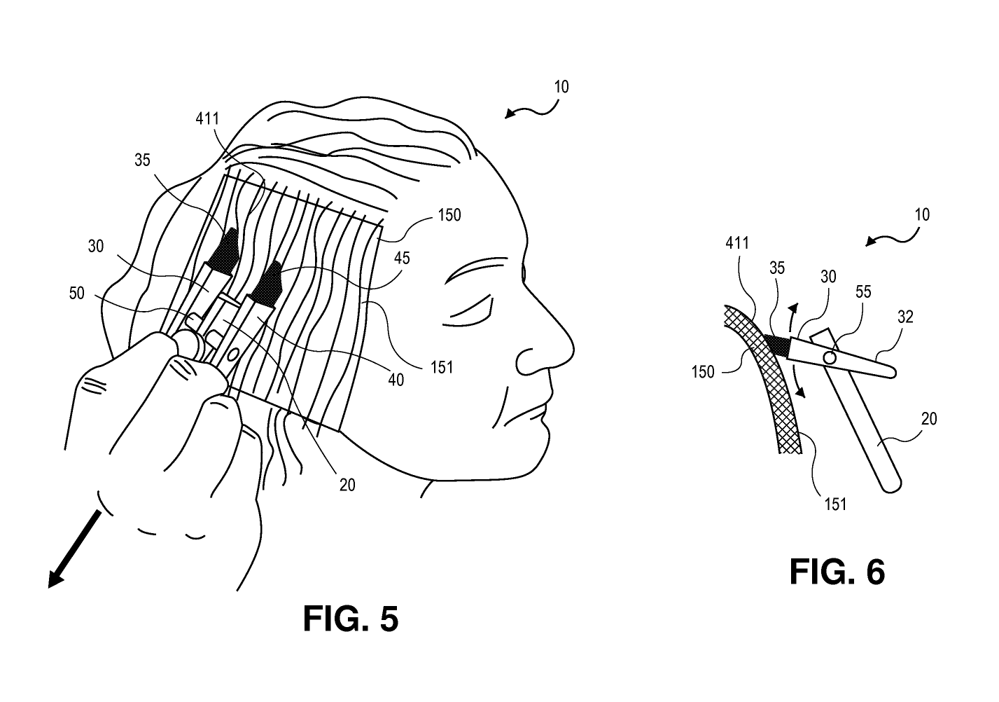

In use, as illustrated in FIG. 5, a foil sheet such as foil sheet 150 may be inserted into the hair such that hair strands, such as hair strands 411, to which coloring agent is to be applied lie generally upon foil surface, such as foil surface 151, of the foil sheet. The foil sheet may be a generally thin flexible sheet of material that may be formed of aluminum (e.g. aluminum foil), various plastics, combinations thereof, and may be coated and/or textured in various ways, and is generally adapted to be inserted into the hair to act as a shield during the application of a coloring agent. The foil sheet, as illustrated in FIG. 5, is positioned underneath hair strands with the hair strands generally organized upon the foil surface of the foil sheet. The user may then apply coloring agent to portions of the hair strands using an applicator, such as applicator 10 (see FIG. 1), which includes handle 20, axle 50 defining axis 53, with the axle 50 secured to the handle 20 generally proximate handle end 24, brush 30 rotationally positionable about axle 50, and companion brush 40 rotationally positionable about axle 50 independently of brush 50 and set apart from the brush 50 in fixed relationship along axis 53.

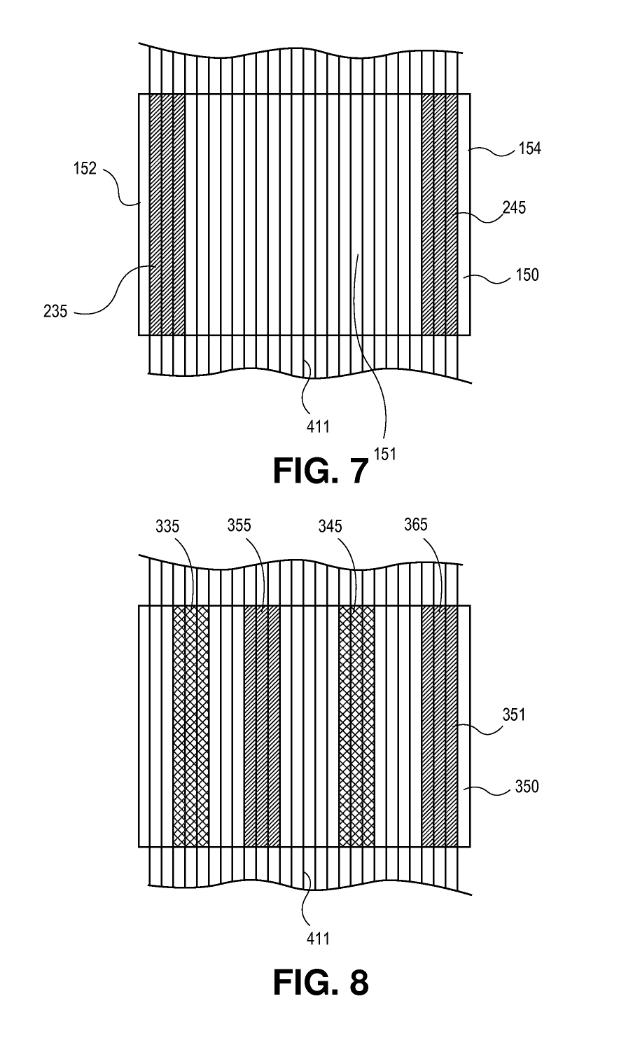

The user may introduce coloring agent upon the bristle sets of the applicator, such as bristle sets 35, 45 of applicator 10 or bristle set 225, 235, 245 of applicator 200, and then drag the bristle sets of the applicator along the hair strands to apply the coloring agent thereto. The applicator, such as applicator 10, may be motioned as indicated by the arrow in FIG. 5 to the drag bristle sets along the hair strands such that the coloring agent generally forms parallel sections, such as sections 235, 245, illustrated in FIG. 7, on the hair strands. Sections 235, 245 may be formed, for example, by brushes 30, 40 respectively, of applicator 10. By positioning sections 235, 245 generally proximate and parallel to sides 152, 154 of foil 150, the coloring agent may tack the hair in the sections 235, 245 to the foil sheet thereby preventing color bleeding, which is the leakage of coloring agent onto the scalp. Applicator 200 may be motioned in a manner similar to that of applicator 10 to apply generally coordinated swirls of coloring agent from bristle sets 225, 235, 245.

The user may position the brush, such as brush 30, 230, and the companion brush, such as brush 40, 240, in secured staggered rotational placement about the axle, such as axle 50, 250, prior to applying coloring agent to portions of the hair strands using the applicator, such as applicator 10, 200. By secured placement it is meant that the brushes are generally locked into rotational position so as not to rotate. In applying the coloring agent to the hair strands, the user may position the brush and the companion brush in secured parallel placement about the axle and in an angled relationship with the handle prior to the step of applying a coloring agent to portions of the strands of hair using an applicator. For example, the brush and the companion brush may be rotationally positioned so that α≈β and so that α, β>0, as illustrated in FIG. 2, and the brush and the companion brush may be secured in this position, for example, by sufficiently increasing the frictional engagement between the brush, the companion brush, and the axle. The frictional engagement between the brush, the companion brush, and the axle may be increased or decreased by, for example, tightening or loosening fasteners 55, 57, respectively. So positioning the brush and the companion brush may facilitate the application of the coloring agent to form parallel sections, or may facilitate the application of the coloring agent in other patterns to achieve thereby various aesthetic effects. The positioning of the brush and the companion brush may be altered during the course of applying coloring agent depending upon the location about the head to which the coloring agent is to be applied and the nature of the aesthetic effect to be achieved.

The user may alter the frictional engagement thereby allowing the brush and the companion brush to rotate about the axle while performing the step of applying a coloring agent to portions of the strands of hair using an applicator. This is generally illustrated in FIG. 5 with respect to applicator 10. As illustrated in FIG. 5, hair strands 411 are organized upon foil surface 151 of foil 150. Brush 30 may rotate about the axle 50 as generally indicated by the arrows in the Figure as bristle group 35 is dragged across hair strands 411 and foil surface 151. Although not included in the Figure, brush 40 would rotate in a similar fashion as bristle group 45 is dragged across hair strands 411 and foil surface 151. Applicator 200 may be employed in a similar fashion to the employment of applicator 10 illustrated in FIG. 5.

The user may rotate the brush and/or the companion brush of the applicator while applying the coloring agent to the hair using the applicator. The user may rotate the brush and/or companion brush by pushing on the handles, such as handles 31, 41, or handles 231, 241 thereof

The user may alter the frictional engagement so that a desired level of force must be applied to the bristle group and/or to the handle to rotate the brush about the axle. The user may alter the frictional engagement so that only minimal or no force will rotate the brush about the axle—the brush rotates essentially freely about the axle. The frictional engagement between the brush and the axle may be similar or may be dissimilar to the frictional engagement between the companion brush and the axle.

In various implementations, the user may form companion parallel sections of coloring agent disposed about the parallel sections of coloring agent. FIG. 8 illustrates parallel sections 335, 345 of coloring agent and companion parallel sections 355, 365 formed on surface 351 of foil sheet 350 using applicators such as applicator 10. The companion parallel sections of coloring agent, such as sections 355, 365, may be formed using a companion applicator, with the companion applicator similar to the applicator. Applicators such as applicator 200 may be employed to form parallel sections or other coordinated applications of coloring agent. Parallel sections, in this context, are merely illustrative and should be understood to encompass not only parallel strips but various other coordinated sections of coloring agent, streaks, swirls, and so forth.

Sections 335, 345 may be formed of a coloring agent that differs from the coloring agent that forms sections 355, 365. The coloring agent that forms sections 335, 345 may have a different base color than the coloring agent that forms sections 355, 365. Accordingly, the user may select the applicator used to apply the coloring agent using an indicator, such as indicator 92, indicative of the base color of the coloring agent, prior to applying the coloring agent. Applicators such as applicator 200 may be employed to form parallel sections or other coordinated applications of coloring agent.

The user may secure the applicator, such as application 10, 200, to a metal fixture using a magnet, such as magnet 88, 288 disposed about applicator. The user may alter the fixed axial relationship between the brush and the companion brush by changing the axle to insert a longer or shorter axle in order to increase or decrease the axial distance between the brush and the companion brush, as desired.

The foregoing discussion along with the Figures discloses and describes various exemplary implementations. These implementations are not meant to limit the scope of coverage, but, instead, to assist in understanding the context of the language used in this specification and in the claims. Accordingly, variations of the apparatus, methods, and compositions of matter that differ from these exemplary implementations may be encompassed by the appended claims. Upon study of this disclosure and the exemplary implementations herein, one of ordinary skill in the art may readily recognize that various changes, modifications and variations can be made thereto without departing from the spirit and scope of the inventions as defined in the following claims.

The invention claimed is:

1. An applicator for the application of a coloring agent to hair, comprising:
a handle;
a axle with an axis, the axle secured to the handle generally proximate a handle end;
a brush rotationally positionable about the axle; and
a companion brush rotationally positionable about the axle independent of the brush and set apart from the brush in fixed relationship along the axis.

2. The apparatus, as in claim 1, wherein the brush is frictionally engaged with the axle to rotate as the brush is applied to a surface with force sufficient to overcome the frictional engagement, and the companion brush is frictionally engaged with the axle to rotate as the companion brush is applied to a surface with force sufficient to overcome the frictional engagement, the companion brush rotates independently of the brush.

3. The apparatus, as in claim 2, wherein the frictional engagement of the brush and the companion brush are independently adjustable between fixed engagement and free rotation.

4. The apparatus, as in claim 1, further comprising:
a color indicator indicative of a base color of said coloring agent disposed about the handle.

5. The apparatus, as in claim 1, further comprising:
a magnet to disposed about the handle to secure the handle to a metal fixture.

6. The apparatus, as in claim 1, wherein the brush and the companion brush are substantially similar in size and shape.

7. The apparatus, as in claim 1, wherein the fixed axial relationship between the brush and the companion brush is alterable.

8. A kit, comprising:
the applicator of claim 1 and further comprising a color indicator indicative of a base color of said coloring agent disposed about the handle;
a concave brush having a concave bristle set in general conformance to the curvature of a human hairline.

9. A method of applying a coloring agent to hair, comprising the steps of:
positioning a foil sheet underneath strands of hair with the strands of hair generally organized upon a surface of the foil sheet; and
applying a coloring agent to portions of the strands of hair using an applicator,
the applicator comprising a handle, a axle of cylindrical shape with an axis, the axle secured to the handle generally proximate a handle end, a brush rotationally positionable about the axle, and a companion brush rotationally positionable about the axle independent of the brush and set apart from the brush in fixed relationship along the axis.

10. The method, as in claim 9, further comprising the step of:
forming parallel sections of coloring agent upon the strands of hair by the step of applying a coloring agent to portions of the strands of hair using the applicator.

11. The method, as in claim 10, further comprising the step of:
forming companion parallel sections of coloring agent disposed about the parallel sections of coloring agent, the companion parallel sections of coloring agent formed using a companion applicator, the companion applicator similarly comprised to the applicator.

12. The method, as in claim 10, further comprising the step of:
tacking strands of hair to the foil sheet thereby preventing color bleeding by the step of forming parallel sections of color upon the strands of hair by the step of applying a coloring agent to portions of the strands of hair using an applicator.

13. The method, as in claim 9, further comprising the step of:
selecting the applicator using an indicator indicative of a base color of the coloring agent, the applicator further comprising the indicator, prior to the step of applying a coloring agent to portions of the strands of hair using an applicator.

14. The method, as in claim 9, further comprising the step of:
securing the applicator to a metal fixture using a magnet disposed about applicator handle, the applicator further comprising the magnet disposed about the handle.

15. The method, as in claim 9, further comprising the step of:
positioning the brush and the companion brush in secured staggered rotational placement about the axle prior to the step of applying a coloring agent to portions of the strands of hair using an applicator.

16. The method, as in claim 9, further comprising the step of;
positioning the brush and the companion brush in secured parallel placement about the axle and in an angled relationship with the handle prior to the step of applying a coloring agent to portions of the strands of hair using an applicator.

17. The method, as in claim 9, further comprising the step of:
rotating the brush and the companion brush about the axle while performing the step of applying a coloring agent to portions of the strands of hair using an applicator.

18. The method, as in claim 9, further comprising the step of:
altering the fixed axial relationship between the brush and the companion brush by changing a spacer placed therebetween.

19. The method, as in claim 9, further comprising the step of:
applying coloring agent to hair generally proximate the hairline using a concave brush having a concave bristle set in general conformance to the curvature of a human hairline.

20. The method, as in claim 9, further comprising the step of;
adjusting independently the frictional engagement of the brush and the companion brush between fixed engagement and free rotation.
